(19) United States
(12) Patent Application Publication
(10) Pub. No.: US 2026/0126978 A1
(43) Pub. Date: May 7, 2026

(54) USING CONTAINERS ON NETWORK DEVICES FOR PROVISIONING COMPUTING DEVICES AT EDGE SITES

(71) Applicants: Bharath Narayan, Bangalore (IN); Eshwara Rajesh Padaru, Bangalore (IN); Gallig Renaud, Grenoble (FR)

(72) Inventors: Bharath Narayan, Bangalore (IN); Eshwara Rajesh Padaru, Bangalore (IN); Gallig Renaud, Grenoble (FR)

(73) Assignee: Hewlett Packard Enterprise Development LP, Spring, TX (US)

(21) Appl. No.: 19/064,862

(22) Filed: Feb. 27, 2025

(30) Foreign Application Priority Data
Nov. 4, 2024 (EP) 24306852.5

(51) Int. Cl. G06F 8/61

(52) U.S. Cl. CPC G06F 8/61

(57) ABSTRACT

In certain examples, a method includes detecting, by a network device, that a computing device at an edge site requires provisioning; obtaining, by the network device, identifying information corresponding to the computing device from the computing device; providing, by the network device, the identifying information to a cloud service device; receiving, from the cloud service device and at a proxy provisioning container executing on the network device, provisioning information corresponding to the computing device; obtaining, by the proxy provisioning container, provisioning items based on the provisioning information; and orchestrating, by the proxy provisioning container, provisioning of the computing device using the provisioning items.

### BACKGROUND

Computing devices (e.g., servers) may be deployed at a variety of locations. Such computing devices often require provisioning (e.g., installation of operating system and software, configuration of settings). Provisioning of computing devices to be deployed at remote locations may be performed prior to shipment of the computing devices to the remote locations (e.g., in a factory).

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims. Aspects of the present disclosure are best understood from the following detailed description when read with the accompanying figures. For a more complete understanding of this disclosure, and advantages thereof, reference is now made to the following descriptions taken in conjunction with the accompanying drawings, in which:

FIG. 1 shows a block diagram of an edge cloud ecosystem 100, in accordance with to one or more examples disclosed herein;

FIG. 2 is a block diagram of a portion of an edge cloud ecosystem, in accordance with to one or more examples disclosed herein;

FIG. 3 illustrates an overview of an example method for provisioning a computing device at an edge site, in accordance with to one or more examples disclosed herein;

FIG. 4 illustrates a block diagram of a computing device, in accordance with one or more examples disclosed herein; and

FIG. 5 illustrates a block diagram of a computing device, in accordance with one or more examples disclosed herein.

The figures are drawn to illustrate various aspects of the disclosure and are not necessarily drawn to scale.

### DESCRIPTION

The following disclosure provides many different examples for implementing different features. Specific examples of components and arrangements are described below to simplify the present disclosure. These are, of course, merely examples and are not intended to be limiting.

Computing devices (e.g., servers) are sometimes deployed at edge sites. An edge site may refer to a location where computing resources (e.g., compute, storage, and/or network resources, and the like) are located away from centralized data centers (e.g., closer to end-users, data sources, and the like). As such, edge sites are often remotely located (e.g., geographically), may be numerous, may be relatively isolated, may have intermittent and/or sporadic connection to outside networks (e.g., the Internet), and may or may not have any qualified information technology personnel available. Such factors may pose challenges for provisioning and maintenance of computing devices located at such edge sites. Provisioning a computing device may include, but is not limited to, configuring the computing device with an operating system, configuring various device and/or component settings, performing any installation and/or updates of various components (e.g., firmware updates), installing relevant software, configuring security measures, and the like.

Provisioning of computing devices may be performed prior to shipping the computing devices to edge sites (e.g., at a factory). However, configurations, software, and the like provisioned for computing devices prior to deployment at an edge site may result in such provisioning being obsolete, out-of-date, and the like, thereby requiring re-provisioning, which may, for example, be prone to failures. Additionally, or alternatively, provisioning of computing devices at an edge site may be performed, at least in part, by pre-configuring the computing devices with certain software that is configured to activate when a computing device is deployed (e.g., connected to a network and powered on), and perform additional provisioning. However, such techniques may require a portion of the computing resources of the computing device, and/or connection (e.g., via a network) to devices external to the edge site.

One or more examples disclosed herein may address at least some of the challenges of provisioning computing devices deployed at edge sites by moving the provisioning activities to being performed on-site after physical deployment of the computing devices by a network device located at the edge site. An edge site generally includes, along with a number of computing devices, one or more network devices for providing network connectivity within and external to the edge site. Network devices are often more reliably powered on, up and running, connected to an external network, and the like. As such, using network devices at edge sites for provisioning computing devices at such edge sites may improve the provisioning of the computing devices at edge sites.

In one or more examples, to set up an edge site includes shipping one or more network devices, any number of computing devices, and any other relevant components to the edge site location. The computing devices are then installed (e.g., into a rack), connected to a source of power, and connected to a network device. In some examples, power be provided via a single connection to a network device, as in a power-over-ethernet (PoE) configuration.

In one or more examples, a network device at an edge site may be configured to obtain information about computing devices that are connected to the network device. Such information may be information that identifies the computing device, and/or portions thereof, such as, for example, serial number, part number, Media Access Control (MAC) addresses (e.g., of network interfaces), management interface information, and the like. As an example, when a computing device is connected to a network device, the connection may be made via a management port and one or more network ports. In one or more examples, a service executing in the control plane of the network device may request and receive, via the management port, information about the computing device.

In one or more examples, the information about the computing device may be provided from the network device to a cloud service device. In one or more examples, a cloud service device is any device external to the edge site that is configured, at least in part, to include provisioning information, and to manage and/or provide services related to devices at an edge site, such as provisioning and managing computing devices. In one or more examples, the cloud service device uses the information received about the computing device from the network device at the edge site to identify the computing device. Based on such an identification, the cloud service device may determine how the computing device is to be provisioned (e.g., what operating system to install, what software to install, what settings to configure, what firmware versions should be installed, and the like).

In one or more examples, the cloud service device may then communicate with a proxy provisioning container executing on the network device to which the computing device is connected and from which information about the computing device was received by the cloud service device. In one or more examples, the network device includes resources (e.g., a small amount of dedicated resources) for executing one or more containers. A proxy provisioning container may be one such container, executing using resources of the network device. The proxy provisioning container may be pre-provisioned on the network device (e.g., such that it executes after the network device is powered on without requiring installation), may be installed on the network device once the network device is connected to an external network, or may be installed on the network device at the edge site (e.g., from a storage device available to the network device).

In one or more examples, the proxy provisioning container of the network device is configured to receive information (e.g., from the cloud service device) related to how a computing device is to be provisioned, and to cause the provisioning to be performed (e.g., orchestrate the provisioning of the computing device). To that end, in one or more examples, the proxy provisioning container may obtain the various installation images, packages, software, firmware, and the like that are to be installed for the provisioning of the computing device. In some examples, such items are obtained from a source external to the network device and/or to the edge site (e.g., the cloud service device, an external repository, and the like). Additionally, or alternatively, all or any portion of such items may be obtained locally from within the edge site. As an example, the shipment of devices to the edge site may have included one or more storage devices (e.g., Universal Serial Bus (USB) keys, multi-media cards, and the like) that are pre-loaded with the items (e.g., operating system installation images, software packages, firmware updates, configuration scripts, and the like). In one or more examples, such pre-loaded items may be shipped to an edge site sometime after a shipment of other components (e.g., computing devices) to the edge site, thereby reducing or eliminating, for example, any potential difference between the current versions of the software to be installed and versions available to be installed at the edge site.

In one or more examples, the proxy provisioning container of the network device may then orchestrate the provisioning of the computing device. Such provisioning may include, for example, initiating the installation of an operating system, installing or updating firmware for various components of the computing device, installing software, and/or configuring settings (e.g., network settings, storage settings, security settings, and the like).

In one or more examples, once the computing device is successfully provisioned, the proxy provisioning container, or another container executing on the network device, may then monitor the computing device during operation, perform ongoing maintenance (e.g., firmware updates, software updates, operating system updates, reconfiguration of settings, and the like). The proxy provisioning container may also perform provisioning when new computing devices are added to the edge site, monitor the health of already provisioned computing devices at the edge site, and perform any other relevant management services. In some examples, monitoring of computing devices (e.g., at an edge site) may also include monitoring any hardware changes that occur (e.g., changes of or replacement of network interface cards). Such hardware changes may, in some examples, be captured by the container monitoring the computing devices, and the changes may be communicated to one or more other devices (e.g., a cloud service device).

Using a network device, and services and proxy provisioning containers executing thereon, to provision computing devices at edge sites may address at least some of the challenges of provisioning computing devices deployed at edge sites, while at the same time, reducing the need for, and possible errors introduced by, pre-provisioning computing devices prior to shipment of such devices to edge sites.

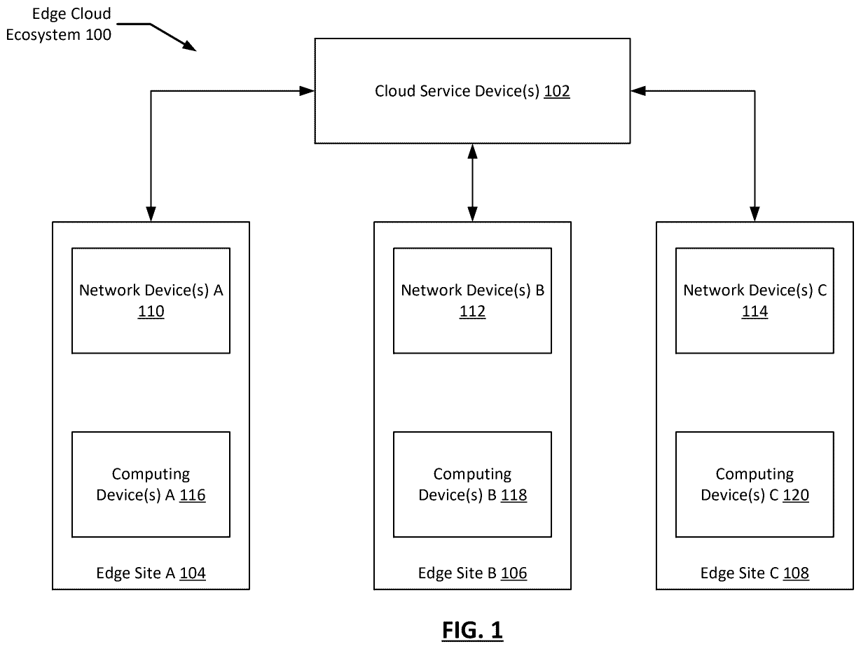

FIG. 1 shows a block diagram of an edge cloud ecosystem 100, in accordance with to one or more examples disclosed herein. The edge cloud ecosystem 100 may include any number of cloud service devices 102, and any number of edge sites (e.g., edge site A 104, edge site B 106, edge site C 106). Each edge site may include any number of network devices (e.g., network device A 110, network device B 112, network device C 114), and any number of computing devices (e.g., computing device A 116, computing device B 118, computing device C 120).

In one or more examples, an edge cloud ecosystem 100 is any collection of devices where some of the devices (e.g., cloud devices) are in one location, and another portion of the devices (e.g., edge devices) exist in another location. As an example, cloud devices may be accessible over the Internet, and be configured to provide various services, computing resources, storage resources, and the like for entities that have local computing resources, but seek to expand the amount of available resources, offload management of resources, and the like. One example of such a service is Edge Cloud as a Service (ECaaS). In such a scenario, an entity (e.g., a particular customer, or company) may have any amount of resources deployed at any number of locations (e.g., edge sites, discussed below), and may seek to have such resources provided by and/or managed, at least in part, by a separate entity providing ECaaS (e.g., an ECaaS provider).

In one or more examples, the edge cloud ecosystem 100 includes any number of cloud service devices (e.g., the cloud service device 102). In one or more examples, the cloud service device 102 is any device configured to provide services for one or more edge sites, such as provisioning and management of devices located at edge sites. Although FIG. 1 shows a single instance of a cloud service device, the edge cloud ecosystem 100 may include any number of cloud service devices 102 without departing from the scope of examples included herein.

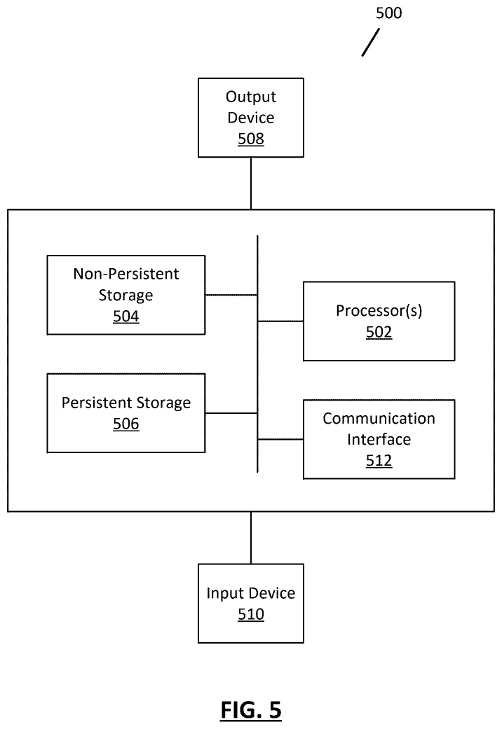

In one or more examples, the cloud service device 102 is a computing device. In one or more examples, as used herein, a computing device may be any single computing device, a set of computing devices, a portion of one or more computing devices, or any other physical, virtual, and/or logical grouping of computing resources. One example of a computing device is shown in FIG. 5, and described below. In one or more examples, a computing device, as used herein, may be any device of any type that is configured to host all or any portion of one or more applications, microservices, clustered environment services, storage services, network services, and/or any other computing function, which may include executing instructions, performing operations, executing functions, performing computations, and the like.

In one or more examples, a computing device is any device, portion of a device, or any set of devices capable of electronically processing instructions and may include, but is not limited to, any of the following: one or more processors (e.g. components that include circuitry), memory (e.g., random access memory (RAM)), input and output device(s), non-volatile storage hardware (e.g., solid-state drives (SSDs), persistent memory (Pmem) devices, hard disk drives (HDDs) (not shown)), one or more physical interfaces (e.g., network ports, storage ports), any number of other hardware components (not shown), and/or any combination thereof.

Examples of computing devices include, but are not limited to, a server (e.g., a blade-server in a blade-server chassis, a rack server in a rack, a desktop server, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, any other type of storage device), a network device, a virtual machine, a virtualized computing environment, a logical container (e.g., for one or more applications), a container pod, an Internet of Things (IoT) device, an array of nodes of computing resources, a supercomputing device, a data center or any portion thereof, and/or any other type of computing device. As one of ordinary skill in the art will appreciate, any of the aforementioned examples of computing devices necessarily require at least some hardware components. As an example, a virtual machine, a container, and/or a container pod, when considered as a computing device herein, include the underlying hardware on which the virtual machine, container, and/or a container pod executes.

In one or more examples, the storage and/or memory of a computing device or system of computing devices may be and/or include one or more data repositories for storing any number of data structures storing any amount of data (e.g., information). In one or more examples, a data repository is any type of storage unit and/or device (e.g., a file system, database, collection of tables, RAM, hard disk drive, solid state drive, and/or any other storage mechanism or medium) for storing data. Further, the data repository may include multiple different storage units and/or devices. The multiple different storage units and/or devices may or may not be of the same type or located at the same physical location.

In one or more examples, any storage and/or memory of a computing device or system of computing devices may be considered, in whole or in part, as non-transitory computer readable mediums storing software and/or firmware, which, when executed by one or more processors, cause the one or more processors to perform operations (e.g., execution of one or more computer programs) in accordance with one or more examples disclosed herein.

The edge cloud ecosystem 100 may include any number of cloud service devices 102, any number of which may be individually or collectively considered a computing device, as used herein. All or any portion of such computing devices may be the same type or be different types of computing devices.

In one or more examples, the cloud service device 102 is operatively connected to any number of edge sites (e.g., 104, 106, 108). As an example, each edge site (e.g., 104, 106, 108) may include one or more network devices (e.g., 110, 112, 114, described below) that are operatively connected to the cloud service device 102. Such a connection may be facilitated, for example, via a network (not shown). As used herein, a network may refer to an entire network or any portion thereof (e.g., a logical portion of the devices within a topology of devices). A network may include a datacenter network, a wide area network, a local area network, a wireless network, a cellular phone network, an InfiniBand network, and/or any other suitable network that facilitates the exchange of information from one part of the network to another (e.g., between devices within and/or connected to the network). A network may be a combination of any of the aforementioned network types. A network may be located at a single physical location or be distributed at any number of physical sites. In one or more examples, a network may be coupled with or overlap with, at least in part, the Internet.

An edge site (e.g., 104, 106, 108) may refer to a location where computing resources (e.g., compute resources, storage resources, network resources, and the like) are located away from centralized data centers (e.g., closer to end-users, data sources, and the like). As such, edge sites are often remotely located (e.g., geographically), may be numerous, may be relatively isolated, may have intermittent and/or sporadic connection to outside networks (e.g., the Internet), and may or may not have any qualified information technology personnel available. Deploying resources at an edge site may allow for reduced latency between devices located at the edge site, reduce network bandwidth required for various operations, allow for local processing of certain operations and applications, allow for continued operations in the absence of outside network connections, and the like. As an example, a retail location (e.g., a store) of a company may constitute one edge site, and the company may have any number of such edge sites.

In one or more examples, each edge site (e.g., 104, 106, 108) includes any number of network devices (e.g., 110, 112, 114). A network device (e.g., 110, 112, 114) may be considered a type of computing device that is configured, at least in part, to provide network access and functionality for any number of other devices to which the network device is operatively connected. In one or more examples, a network device (e.g., 110, 112, 114) includes any number of components (not shown), such as, for example, network chips, field programmable gate arrays (FPGAs), application specific integrated circuits (ASICs), indicator lights (not shown), fans (not shown), power supply units, power distribution units, and the like. As an example, at least a portion of such hardware components may be included as part one or more of what may be referred to as line cards of a network device. In one or more examples, a line card, used here merely by way of example, refers to a collection of hardware components (e.g., connected by a printed circuit board) that include one or more physical interfaces (e.g., network ports) and any number of additional hardware components (e.g., ASICs, FPGAs, TCAMs, processor components, other memory components, and the like.) that are used, at least in part, to store forwarding information and process network traffic. Forwarding information (which may include all or any portion of information that may be referred to as the ‘FIB’) may, for example, be stored (e.g., in various tables) in one or more hardware components of the line cards, such as MAC tables, route table entries, multicast forwarding entries, and the like, which is sometimes referred to as being part of a data plane. In one or more examples, a network device includes information, such as a routing information base (RIB) that includes information (e.g., obtained from various routing protocols) that may be used to program components of the network device to propagate network data units. A network device may include any other components in any arrangement without departing from the scope of examples described herein, and, as such is not limited to any arrangement of components shown in any figure and/or described herein.

In one or more examples, as discussed above, a network device (e.g., 110, 112, 114) includes at least one physical interface (and often two or more such physical interfaces). In one or more examples, physical interfaces are any hardware, software, or combination thereof that include functionality to receive and/or transmit network data units (e.g., packets, frames, and the like) or any other information to or from a network device. Physical interfaces may include any interface technology, such as, for example, optical, electrical, and the like. Physical interfaces may be configured to interface with any transmission medium (e.g., optical fiber, copper wire(s), and the like).

In one or more examples, physical interfaces include and/or are operatively connected to any number of components used in the processing of network traffic. For example, a given physical interface may include a PHY (not shown), which is circuitry that connects a physical information propagation medium (e.g., a wire) to other components (e.g., the hardware components of a line card), which process network traffic. In one or more examples, physical interfaces include and/or are operatively connected to a transceiver, which provides the connection between the physical information transmission medium and the PHY. A PHY may also include any number of other components, such as, for example a serializer/deserializer (SERDES), and encoder/decoder, and the like. A PHY may, in turn, be operatively connected to other any number of other components, such as, for example, a media access control (MAC) sublayer. Such a sublayer, may, in turn, be operatively connected to still other higher layer processing components, all of which form a series of components used in the processing of network traffic being received, transmitted, or otherwise used by a network device for any purpose.

In one or more examples, a network device includes any software (e.g., various daemons, a state database, containers, and the like.), firmware, and the like, configured to perform and/or allow other components to perform various functions of the network device (e.g., to process network traffic, perform management functions). Such software may, for example, execute using one or more processors of a network device, or any other hardware resource of a network device capable of executing software.

Examples of a network device (e.g., 110, 112, 114) include, but are not limited to, a switch, a router, a multilayer switch, a fibre channel device, an InfiniBand® device, and the like. A network device is not limited to the aforementioned specific examples. As an example, any computing device (discussed above) may be configured, at least in part, as a network device as used herein.

In one or more examples, a network device (e.g., 110, 112, 114) includes functionality to receive network data units (e.g., frames, packets, tunneling protocol frames, and the like at any of the physical interfaces (e.g., ports) of the network device, and to process the network data units (e.g., to receive, transmit, consume, and the like). In one or more examples, processing a network traffic includes, but is not limited to, a series of one or more lookups (e.g., longest prefix match (LPM) lookups, forwarding equivalence class (FEC) lookups, and the like) and corresponding actions (e.g., forward from a certain egress port, add a labeling protocol header, rewrite a destination address, encapsulate, decapsulate, and the like). Examples of network traffic processing include, but are not limited to, determining: (i) whether to take a security action (e.g., drop the network traffic data unit); (ii) whether to mirror the network traffic data unit; and/or (iii) how to route/forward the network traffic data unit in order to transmit the network traffic data unit from an interface of the network device. A network device may perform other operations, functions, and the like with respect to a network data unit without departing from the scope of examples disclosed herein.

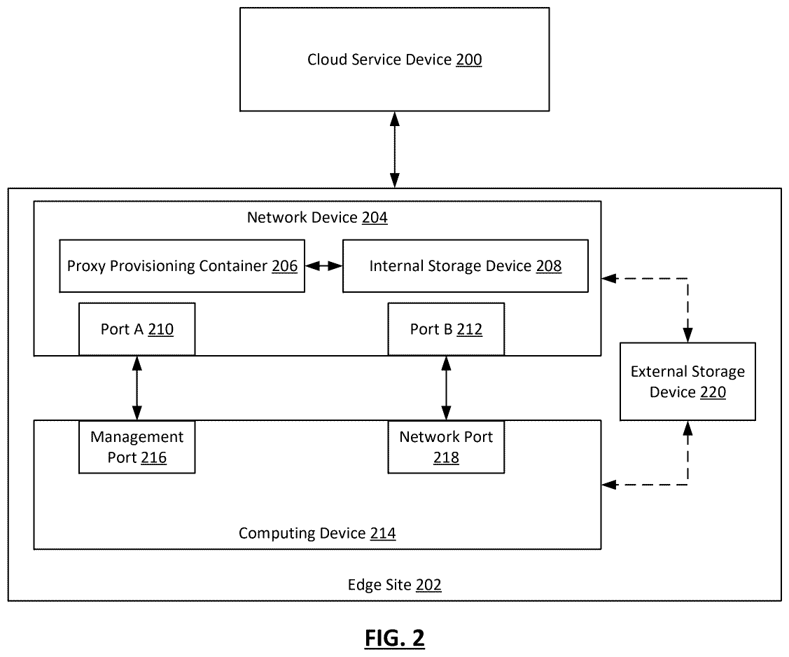

In one or more examples, a network device (e.g., 110, 112, 114) deployed at an edge site (e.g., 104, 106, 108) is operatively connected to all or any portion of the devices (e.g., computing devices) deployed at the edge site, and also operatively connected, at least some of the time, to an external network (e.g., the Internet). In one or more examples, such a connection to an external network provides an operative connection between the network device and one or more cloud service devices (e.g., 102). Network devices deployed at an edge site are discussed further in the description of FIG. 2, below.

In one or more examples, an edge site (e.g., 104, 106, 108) includes any number of computing devices (e.g., 116, 118, 120), which are described above, and also below, in the description of FIG. 5. In one or more examples, to perform and/or execute whatever tasks, operations, applications, and the like that a computing device at an edge site is intended for, a computing device is provisioned. Provisioning a computing device may include, but is not limited to, configuring the computing device with an operating system, configuring various device settings, performing any installation and/or updates of various components (e.g., firmware updates), installing relevant software, configuring security measures, and the like. In one or more examples, provisioning computing devices (e.g., 116, 118, 120) at edge sites (104, 106, 108) may be performed, at least in part, via network devices (e.g., 110, 112, 114) co-located at the edge sites, which is discussed further in the descriptions of FIGS. 2-4, below.

While FIG. 1 shows a particular configuration of devices and/or components, other configurations may be used without departing from the scope of examples described herein. Accordingly, examples disclosed herein should not be limited to the configuration of devices and/or components shown in FIG. 1.

FIG. 2 is a block diagram of a portion of an edge cloud ecosystem (e.g., the edge cloud ecosystem 100 of FIG. 1), in accordance with to one or more examples disclosed herein. As shown in FIG. 2, the portion of the edge cloud ecosystem includes a cloud service device 200, an edge site 202, a network device 204, a computing device 214, and, optionally, an external storage device 220. The network device 204 may include a proxy provisioning container 206, an internal storage device 208, and any number of ports (e.g., port A 210, port B 212). The computing device 214 may include a management port 216, and a network port 218. Each of these components is described below.

In one or more examples, the cloud service device 200 may be the same or substantially similar to the cloud service device(s) 102 shown in FIG. 1 and discussed above. As an example, the cloud service device 200 may be a computing device (discussed above in the description of FIG. 1 and below in the description of FIG. 5). In one or more examples, a cloud service device (e.g., 200) may provide any number of ECaaS related services for edge sites to which the cloud service device 200 is operatively connected. In one or more examples, when an edge site (e.g., 202) is to be deployed, information related to the edge site may be provided to the cloud service device 200.

As an example, a particular customer may seek to deploy a number of edge sites at various locations, and may seek the services of an ECaaS provider to facilitate such deployments. Such a customer may work with the ECaaS provider to define the edge sites, the locations, the devices (e.g., network devices, computing devices), and topology intended for the edge sites. To facilitate the deployment of the edge sites, the ECaaS provider may obtain, build, or otherwise provide the various devices to be deployed at the various edge sites. The cloud service device may then be provided with the information regarding the edge sites to be deployed, the topology to be implemented at such edge sites, and information about the devices to be provided at those sites. Such information may include, but is not limited to, identifying information of the devices and/or portions thereof (e.g., serial numbers, part numbers, MAC addresses, and the like). In one or more examples, the cloud service device is also provided with, or otherwise obtains, the intended configuration of the devices at the edge sites, which will inform how such devices are to be provisioned after arrival at the edge sites. Such intended configuration information may include, but is not limited to, operating system to be installed, other software to be installed, virtual machine environments to be deployed, container environments to be deployed, configuration settings, storage settings, network settings, security settings, and the like for each of the computing devices to be deployed at the edge sites.

In one or more examples, the cloud service device 200 is operatively connected to a network device 204 at an edge site 202. The edge site 202 may be the same as or substantially similar to any of the edge sites (104, 106, 108) shown in FIG. 1 and described above. The network device 204 may be the same or substantially similar to any of the network devices (110, 112, 114) shown in FIG. 1 and described above.

In one or more examples, the network device 204 may be configured to obtain information about computing devices (e.g., the computing device 214) that are connected to the network device 204. Such information may be information that identifies the computing device 214, and portions therein, such as, for example, serial number, part number, MAC addresses (e.g., of network interfaces), and the like. As an example, when the computing device 214 is connected to the network device 204, a connection may be made via a management port, such as the management port 216 of the computing device 214 connected to the port A 210 of the network device 204, and one or more network ports, such as the network port 218 of the computing device 214 connected to the port B 212 of the network device 204. Although FIG. 2 shows the management port 216 and the network port 218 as separate ports, one of ordinary skill in the art will appreciate that these ports may be the same physical port. In one or more examples, a service (not shown) executing, for example, on the network device 204 may request and receive (or just receive upon connection), via the management port 216, the information about the computing device 214. Such a service may be separate from, or a part of, the proxy provisioning container 206 (discussed further below).

In one or more examples, the information about the computing device 214 may be provided from the network device 204 to the cloud service device 200. In one or more examples, the cloud service device 200 uses the information received about the computing device 214 from the network device 204 at the edge site 202 to identify the computing device 214. Based on such an identification, the cloud service device 200 may determine how the computing device 214 is to be provisioned (e.g., what operating system to install, what software to install, what settings to configure, what firmware versions should be installed, and the like).

In one or more examples, the cloud service device 200 may then communicate with a proxy provisioning container 206 executing on the network device 204 to which the computing device 214 is connected, and from which information about the computing device 214 was received by the cloud service device 200. In one or more examples, the network device 204 includes resources (e.g., a relatively small amount of dedicated resources) for executing one or more containers. In one or more examples, a container is a lightweight, standalone, and executable package that includes everything needed to run a piece of software, including the code, runtime, system tools, libraries, and settings. The proxy provisioning container 206 may be one such container, executing using resources of the network device 204. The proxy provisioning container 206 may be pre-provisioned on the network device 204 (e.g., such that it executes when the network device 204 is powered on), may be installed on the network device 204 once the network device is connected to an external network, or may be installed on the network device 204 at the edge site 202, for example from an external storage device (e.g., 220) or an internal storage device (e.g., 208) available to and accessible by the network device 204. As another example, the proxy provisioning container 206 may be installed on the network device during a factory installation process.

In one or more examples, the proxy provisioning container 206 of the network device 204 is configured to receive information (e.g., from the cloud service device 200) related to how the computing device 214 is to be provisioned, and to cause the provisioning to be performed (e.g., orchestrate the provisioning of the computing device 214). To that end, in one or more examples, the proxy provisioning container 206 may obtain the various installation images, packages, software, firmware, and the like that are to be installed as part of the provisioning of the computing device 214. In some examples, such items are obtained from a source external to the edge site (e.g., the cloud service device, an external repository, and the like). Additionally, or alternatively, all or any portion of such items may be obtained locally from within the edge site (e.g., from the external storage device 220 and/or the internal storage device 208 of the network device 204). As an example, the shipment of devices to the edge site 202 may have included one or more storage devices (e.g., Universal Serial Bus (USB) keys, multi-media cards, and the like) that are pre-loaded with the items (e.g., operating system installation images, software packages, firmware updates, and the like).

In one or more examples, the proxy provisioning container 206 of the network device 204 may then orchestrate the provisioning of the computing device 214. Such provisioning may include, for example, initiating the installation of an operating system, installing or updating firmware for various components of the computing device, installing software, and/or configuring settings (e.g., network settings, storage settings, security settings, and the like).

In one or more examples, once the computing device 214 is successfully provisioned, the proxy provisioning container 206, or another container executing on the network device 204 may then monitor the computing device 214 during operation, and perform ongoing monitoring and maintenance (e.g., firmware updates, software updates, operating system updates, reconfiguration of settings, and the like). The proxy provisioning container 206 may also perform provisioning when new computing devices (not shown) are added to the edge site, monitor the health of already provisioned computing devices at the edge site, and perform any other relevant management services.

While FIG. 2 shows a particular configuration of components, other configurations may be used without departing from the scope of examples described herein. For example, any of the components of FIG. 2 may be grouped in sets of one or more components which may exist and execute as part of any number of separate and operatively connected devices. As another example, a single component may be configured to perform all, or any portion of the functionality performed by the all or any portion of the components shown in FIG. 2. Accordingly, examples disclosed herein should not be limited to the configuration of components shown in FIG. 2.

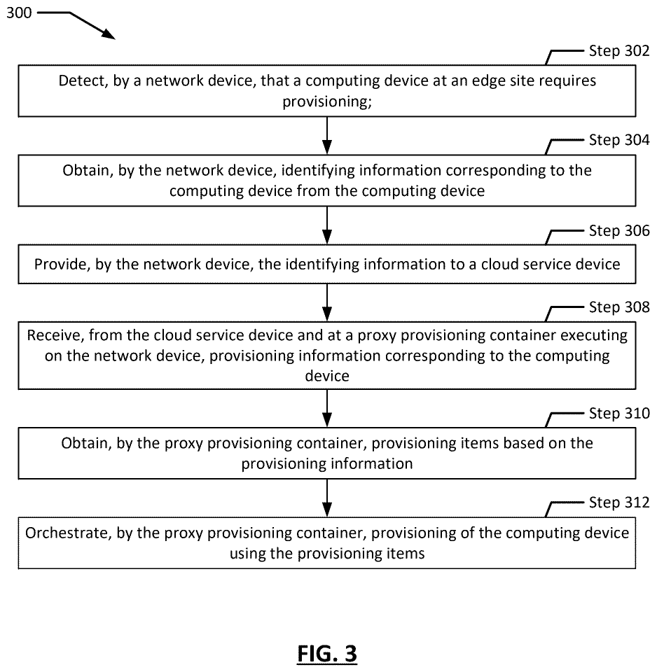

FIG. 3 illustrates an overview of an example method for provisioning a computing device at an edge site, in accordance with to one or more examples disclosed herein.

The method 300 may be performed, at least in part, by one or more devices and/or components of a edge cloud ecosystem (e.g., the edge cloud ecosystem 100 of FIG. 1). As such, all or any portion of the method 300 may be performed by a network device (e.g., the network device 204 of FIG. 2), operating in conjunction with a cloud service device (e.g., the cloud service device 200 of FIG. 2) to provision a computing device (e.g., the computing device 214 of FIG. 2) at an edge site (e.g., the edge site 202 of FIG. 2).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3 and/or steps not shown in FIG. 3.

In Step 302, the method 300 includes detecting, by a network device (e.g., the network device 204 of FIG. 2), that a computing device (e.g., the computing device 214 of FIG. 2) at an edge site (e.g., the edge site 202 of FIG. 2) requires provisioning. In one or more examples, the network device may detect that the computing device requires provisioning when the network device is powered on, and the computing device is connected to the network device via one or more ports and powered on. As an example, a management port and a network port of the computing device may be connected to ports of the network device (e.g., as the edge site is physically configured by onsite personnel), and the network device may detect the connection(s).

In Step 304, the method 300 includes obtaining, by the network device (e.g., the network device 204 of FIG. 2), identifying information corresponding to the computing device (e.g., the computing device 214 of FIG. 2) from the computing device. In one or more examples, the network device is configured to, after detecting the connection of the computing device, request information (e.g., identifying information) from the computing device (e.g., via a management port of the computing device). As an example, the network device may request from the computing device serial numbers, part numbers, MAC addresses, and the like. Such information may be requested by a service executing on the network device, by a proxy provisioning container (e.g., the proxy provisioning container 206 of FIG. 2) executing on the network device, and the like. In one or more examples, although not shown in FIG. 3, to obtain the aforementioned identifying information from the computing device (e.g., via a management port), the network device may obtain relevant credentials (e.g., from a cloud service device) to log into a management interface of the computing device via the management port. In one or more examples, after such credentials are successfully verified, the network device may be able to obtain additional identifying information and/or perform additional validation related to the computing device (e.g., verifying the existence of expected certificates).

In Step 306, the method 300 includes providing, by the network device (e.g., the network device 204 of FIG. 2), the identifying information (e.g., of the computing device) to a cloud service device (e.g., the cloud service device 200 of FIG. 2). The information related to the computing device may be provided from the network device to the cloud service device, for example, over a network, such as the Internet. In one or more examples, the cloud service device uses all or any portion of the identifying information of the computing device to identify the computing device, and to obtain provisioning information related thereto. Such provisioning information may include, but is not limited to, an operating system version to be installed on the computing device, firmware versions for various components of the computing device, software packages to be installed on the computing device, various configuration settings (e.g., storage, network, security, and the like) to be configured on the computing device, and the like. The provisioning information may be obtained by the cloud service device, for example, by using the identifying information of the computing device received from the network device to look up the intended configuration of the computing device as previously determined by the entity deploying the edge site working on conjunction with an ECaaS provider.

In Step 308, the method 300 includes receiving, from the cloud service device (e.g., the cloud service device 200 of FIG. 2) and at a proxy provisioning container (e.g., the proxy provisioning container 206 of FIG. 2) executing on the network device (e.g., the network device 204 of FIG. 2), provisioning information corresponding to the computing device (e.g., the computing device 214 of FIG. 2). The provisioning information may be provided to the network device from the cloud service device, for example, via a network connection between the cloud service device and the network device.

In Step 310, the method 300 includes obtaining, by the proxy provisioning container (e.g., the proxy provisioning container 206 of FIG. 2), provisioning items based on the provisioning information. The provisioning items may include, but are not limited to, an operating system installation image, any number of firmware installation packages, any number of software packages, any number of configuration settings scripts, and the like. The provisioning items may be obtained, at least in part, from any storage location accessible to the network device, such as internal storage devices (e.g., USB keys, flash drives, multi-media cards, and the like), external storage devices of the edge site (e.g., storage devices provided as part of the set of devices deployed at the edge site), and/or storage locations external to the edge site (e.g., the cloud service device, an external repository, and the like).

In Step 312, the method 300 includes orchestrating, by the proxy provisioning container (e.g., the proxy provisioning container 206 of FIG. 2), provisioning of the computing device (e.g., the computing device 214 of FIG. 2) using the provisioning items. Orchestrating provisioning of the computing device may include, but is not limited to, causing installation of an operating system, causing installation of software, causing installation and/or update of firmware, configuring various settings (e.g., security settings, network settings, storage settings, and the like), and/or any other actions to put the computing device in a condition to be used for its intended purpose at the edge site.

Although not shown in FIG. 3, after orchestrating the provisioning of the computing device, the proxy provisioning container (or a different container executing on the network device) may perform on-going monitoring of the computing device at the edge site, which may include obtaining health metrics from the computing device, ensuring that software, firmware, operating system, and the like are up-to-date, maintaining and/or updating various configuration settings as needed, and any other relevant services to manage the computing device. Thus, as an example, a cloud service device of an ECaaS provider may provide ongoing management, at least in part, of computing devices at edge sites via a proxy provisioning container executing on a network device at such an edge site.

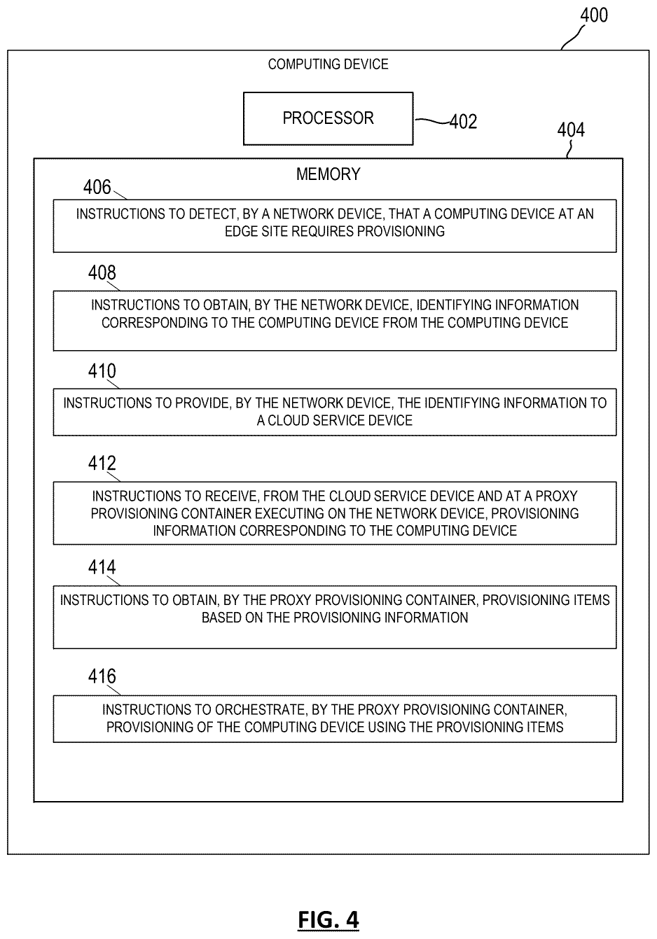

FIG. 4 illustrates a block diagram of a computing device 400, in accordance with one or more examples disclosed herein. The computing device 400 may be an example of the various computing devices (e.g., the cloud service device 102 of FIG. 1, the cloud service device 200 of FIG. 2, the network devices (110, 112, 114) of FIG. 1, the network device 204 of FIG. 2, the computing devices (116, 118, 120) of FIG. 1, the computing device 214 of FIG. 2) described above and/or of the computing device 500, described below. In some examples, the computing device 400 is a network device. As discussed above in the descriptions of FIG. 1, FIG. 2, and FIG. 3, the computing device 400 may be used to implement all or any portion of the various components shown in FIG. 1 and described above and/or to perform all or any portion of the method 300 shown in FIG. 3 and described above.

The computing device 400 may include one or more processors 402 and memory 404. The memory 404 may include a non-transitory computer-readable medium that stores programming for execution by one or more of the one or more processors 402. In this implementation, one or more modules within the computing device 400 may be partially or wholly embodied as software for performing any functionality described in this disclosure. The computing device 400 may be, for example, configured to perform the method 300 shown in FIG. 3 and described above, by executing instructions included in the memory 404 and executed by the one or more processors 402.

For example, the memory 404 may include instructions 406 to detect, by a network device, that a computing device at an edge site requires provisioning (e.g., as described above in reference to Step 302 of FIG. 3).

For example, the memory 404 may include instructions 408 to obtain, by the network device, identifying information corresponding to the computing device from the computing device (e.g., as described above in reference to Step 304 of FIG. 3).

For example, the memory 404 may include instructions 410 to provide, by the network device, the identifying information to a cloud service device (e.g., as described above in reference to Step 306 of FIG. 3).

For example, the memory 404 may include instructions 412 to receive, from the cloud service device and at a proxy provisioning container executing on the network device, provisioning information corresponding to the computing device (e.g., as described above in reference to Step 308 of FIG. 3).

For example, the memory 404 may include instructions 414 to obtain, by the proxy provisioning container, provisioning items based on the provisioning information (e.g., as described above in reference to Step 310 of FIG. 3).

For example, the memory 404 may include instructions 416 to orchestrate, by the proxy provisioning container, provisioning of the computing device using the provisioning items (e.g., as described above in reference to Step 312 of FIG. 3).

FIG. 5 illustrates a block diagram of a computing device, in accordance with one or more examples of this disclosure. As discussed above, examples described herein may be implemented, at least in part, using computing devices, and the computing device 500 shown in FIG. 5 may be such a computing device. For example, all or any portion of the components shown in FIG. 1 (e.g., the cloud service device 102, the network devices (e.g., 110, 112, 104), the computing devices (e.g., 116, 118, 120)) and/or FIG. 2 (e.g., the cloud service device 200, the network device 204, the computing device 214) may be implemented, at least in part using a computing device such as the computing device 500, and may include all or any portion of the components of the computing device 500 shown in FIG. 5 and described below.

In one or more examples, a computing device (e.g., the computing device 500) is any device, portion of a device, or any set of devices capable of electronically processing instructions and may include, but is not limited to, any of the following: one or more processors (e.g. components that include circuitry) (e.g., the processor 502), memory (e.g., random access memory (RAM)) (not shown), input and output device(s) (e.g., the non-persistent storage 506), non-volatile storage hardware (e.g., solid-state drives (SSDs), persistent memory (Pmem) devices, hard disk drives (HDDs) (not shown)), one or more physical interfaces (e.g., network ports, storage ports) (e.g., the persistent storage 506), any number of other hardware components (not shown), and/or any combination thereof. As used herein, a processor may be any component that can be configured to execute operations, processes, threads, and the like. In some examples, a computing device (e.g., the computing device 500) may include any number of heterogeneous processors.

The computing device 500 may include a communication interface 512 (e.g., Bluetooth interface, infrared interface, network interface, optical interface, any other type of communication interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be a central processing unit (CPU), a multi-core CPU, an application specific integrated circuit (ASIC), a graphics processing unit (GPU), a data processing unit (DPU), a tensor processing units (TPU), an associative processing unit (APU), a vision processing units (VPU), a quantum processing unit (QPU), and/or various other processing units that use special purpose hardware (e.g., field programmable gate arrays (FPGAs), System-on-a-Chips (SOCs), digital signal processors (DSPs)). Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, CAMs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not included in a drawing. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, a network device, or a processing device to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, operative connection, and variations thereof, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. A network device, comprising:
one or more processors; and
one or more non-transitory computer readable media storing instructions which, when executed by the one or more processors, cause the one or more processors to:
detect, by the network device, that a computing device at an edge site requires provisioning;
obtain, by the network device, identifying information corresponding to the computing device from the computing device;
provide, by the network device, the identifying information to a cloud service device;
receive, from the cloud service device and at a proxy provisioning container executing on the network device, provisioning information corresponding to the computing device;
obtain, by the proxy provisioning container, provisioning items based on the provisioning information; and
orchestrate, by the proxy provisioning container, provisioning of the computing device using the provisioning items.

2. The network device of claim 1, wherein to detect, by the network device, that the computing device at the edge site requires provisioning, the instructions further cause the one or more processors to:
detect that the computing device is connected to the network device via at least one of a management port and a network port of the computing device.

3. The network device of claim 1, wherein to obtain, by the network device, the identifying information corresponding to the computing device from the computing device, the instructions further cause the one or more processors to:
request, by the network device, the identifying information from a management component of the computing device.

4. The network device of claim 1, wherein the provisioning information comprises one or more of an operating system version, a firmware version, a software package, and a configuration setting to be provisioned to the computing device.

5. The network device of claim 1, wherein the provisioning items are obtained from a remote location separate from the edge site.

6. The network device of claim 1, wherein the provisioning items are obtained from a storage device at the edge site that is accessible to the network device.

7. The network device of claim 1, wherein the provisioning items comprise at least one of an operating system installation image, a firmware installation package, and a software installation package.

8. The network device of claim 7, wherein, after orchestrating the provisioning of the computing device, the instructions further cause the one or more processors to:
perform, by the proxy provisioning container, on-going maintenance monitoring of the computing device; and
orchestrate, by the proxy provisioning container, an update of at least one of an operating system, a firmware, a software application, and a configuration setting of the computing device.

9. The network device of claim 1, wherein the identifying information comprises at least one of a serial number, a part number, and a Media Access Control (MAC) address of the computing device.

10. A computer-implemented method, comprising:
detecting, by a network device, that a computing device at an edge site requires provisioning;
obtaining, by the network device, identifying information corresponding to the computing device from the computing device;
providing, by the network device, the identifying information to a cloud service device;
receiving, from the cloud service device and at a proxy provisioning container executing on the network device, provisioning information corresponding to the computing device;
obtaining, by the proxy provisioning container, provisioning items based on the provisioning information; and
orchestrating, by the proxy provisioning container, provisioning of the computing device using the provisioning items.

11. The computer-implemented method of claim 10, wherein detecting, by the network device, that the computing device at the edge site requires provisioning comprises:
detecting that the computing device is connected to the network device via at least one of a management port and a network port of the computing device.

12. The computer-implemented method of claim 10, wherein obtaining, by the network device, the identifying information corresponding to the computing device from the computing device comprises:
requesting, by the network device, the identifying information from a management component of the computing device.

13. The computer-implemented method of claim 10, wherein the provisioning information comprises one or more of an operating system version, a firmware version, a software package, and a configuration setting to be provisioned to the computing device.

14. The computer-implemented method of claim 10, wherein the provisioning items are obtained from a remote location separate from the edge site.

15. The computer-implemented method of claim 10, wherein the provisioning items are obtained from a storage device at the edge site that is accessible to the network device.

16. The computer-implemented method of claim 10, wherein the provisioning items comprise at least one of an operating system installation image, a firmware installation package, and a software installation package.

17. The computer-implemented method of claim 16, wherein, after orchestrating the provisioning of the computing device, the method further comprises:
performing, by the proxy provisioning container, on-going maintenance monitoring of the computing device; and
orchestrating, by the proxy provisioning container, an update of at least one of an operating system, a firmware, a software application, and a configuration setting of the computing device.

18. The computer-implemented method of claim 10, wherein the identifying information comprises at least one of a serial number, a part number, and a Media Access Control (MAC) address of the computing device.

19. A non-transitory computer-readable medium storing programming for execution by one or more processors, the programming comprising instructions to:
detect, by a network device, that a computing device at an edge site requires provisioning;
obtain, by the network device, identifying information corresponding to the computing device from the computing device;
provide, by the network device, the identifying information to a cloud service device;
receive, from the cloud service device and at a proxy provisioning container executing on the network device, provisioning information corresponding to the computing device;
obtain, by the proxy provisioning container, provisioning items based on the provisioning information; and
orchestrate, by the proxy provisioning container, provisioning of the computing device using the provisioning items.

20. The non-transitory computer-readable medium of claim 19, wherein the provisioning information comprises one or more of an operating system version, a firmware version, a software package, and a configuration setting to be provisioned to the computing device.
